(19) United States
(12) Patent Application Publication
(10) Pub. No.: US 2004/0265447 A1
(43) Pub. Date: Dec. 30, 2004

(54) Hot fill container and closure and associated method

(76) Inventor: Subodh K. Raniwala, Mundelein, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/606,439

(22) Filed: Jun. 26, 2003

(51) Int. Cl. A23B 4/00

(52) U.S. Cl. 426/397

(57) ABSTRACT

A method for hot-filling and closing a polymer container is disclosed in which one of the closure for the container and the head space area of the container is provided with a hole covered with a hydrophobic air permeable membrane. The container is then filled with a hot liquid and the filled container is closed but for the air permeable component. The filled container is then cooled with the pressure between the interior of the container and the ambient pressure being equalized due to the air permeable membrane. Subsequent to cooling, an air-tight seal is provided over the membrane-covered hole. An associated container and closure cap is also disclosed.

### BACKGROUND OF THE INVENTION

The present invention relates to a method for hot filling containers and, more particularly, to a hot-filling method and an associated container or closure.

In order to maintain product quality and consumer safety, most foodstuffs are packaged in a hot-fill operation in which the foodstuffs are placed in the containers while hot. During filling, the container subjected to elevated temperatures (i e., the product temperature, which is typically on the order of 82° C., or higher), sealed, and then cooled.

Hot-filling is commonly used in the bottling of beverages, such as fresh or frozen drinks, fruit juices, isotonic (sports) beverages, etc. These products are typically packaged in PET bottles, which are light, tough, and well suited to the lifestyles of today's consumers.

The design of PET bottles for use in hot-fill operations is not a simple matter. At elevated temperatures, PET softens and loses its shape. The bottles are subjected to hydrostatic pressure exerted on the sidewalls of the container by the weight of the hot liquid, causing the sidewalls to bulge outwardly. During capping, further swelling of the container occurs as the air in head space expands. Finally, as the bottle cools, the volume of the contents, both liquid and air, contracts, causing the bottle sidewalls to collapse inwardly.

To prevent excessive or uncontrolled distortion of the container upon cooling, hot-fill containers are commonly formed with vacuum panels in the middle portion of the sidewalls. As a container is cooled, the vacuum panels move inwardly to accommodate the vacuum formed in the interior of the container.

The need for vacuum panels complicates meeting other packaging requirements, such as providing the mid-section of the bottled with consumer information, promotional graphics, and a grippable profile. Vented container closures incorporating hydrophobic membranes (i.e., membranes that allow air but not liquid to pass therethrough) are known. Their use would relieve the negative internal pressure experienced during container cooling and still seal the container against leakage. However, because such vented caps also permit gaseous fluids to migrate into the heads space of the bottle, both the quality (e.g. the taste profile) and the safety of the contents could potentially be compromised.

Accordingly, it is an object of the present invention to provide a method for hot-filling PET containers that provides for venting during cooling and an air tight seal thereafter.

It is a related object to provide a PET container and/or closure that can be used in the method.

### SUMMARY OF THE INVENTION

These objects, as well as others that will become apparent upon reference to the following Detailed Description and accompanying drawings, are achieved by a method for hot-filling and capping a polymer container in which either the closure for the container or the head space area of the container is provided with a hole covered with a hydrophobic air permeable membrane. The container is then filled with a hot liquid and the cap is applied to the filled container. The filled container is then cooled with the pressure between the interior of the container and the ambient pressure being equalized due to the flow of air across the air permeable membrane. Subsequent to cooling, an air-tight seal is provided over the membrane-covered hole. An associated container and/or closure cap that is used in the method is also disclosed.

### BRIEF DESCRIPTION OF THE FIGURES OF THE DRAWING

FIG. 1 is a partial fragmentary view of a vented container/closure in accordance with the present invention.

FIG. 2 is a partial fragmentary view of a vented container/closure in accordance with the present invention with the vent being sealed.

### DETAILED DESCRIPTION

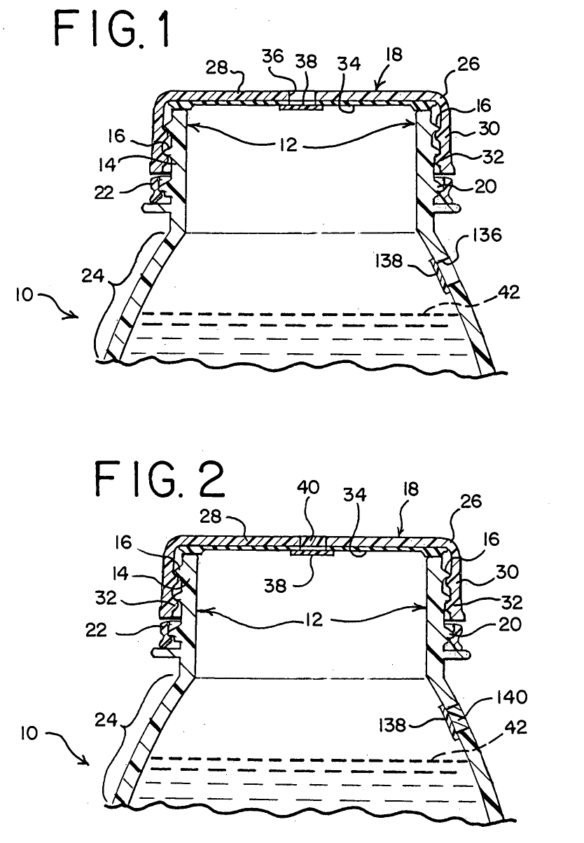

Turning to the drawings, there is seen a container 10 (in partial fragmentary view) and its associated closure 18 in accordance with the present invention. Specifically, in FIG. 1, the shoulder and neck portion of a vented polymeric bottle or container and closure cap is shown with vent being open, while in FIG. 2, the vent is sealed.

The container 10 includes, starting at the top, an open mouth 12 defined by a neck finish 14. The neck finish 14 of this embodiment includes external threads 16 for receiving the screw-on closure cap 18 and a rib 20 for retaining a tamper-evident ring 22 that is frangibly attached to the closure cap 18.

Beneath the neck finish 14, the container 10 includes a shoulder portion 24 that generally increases in diameter from the neck finish 14 to the container mid-section (not shown), which can be of a generally cylindrical configuration. The container mid-section, in turn, terminates in the container base (also not shown).

As is well-known, the container 10 is typically blow molded from an injection-molded preform that may be made from various polymer resins, such as polyesters, polyolefins, polycarbonates, nitrites and copolymers thereof. Bi-axially oriented polyethylene terephthalate (PET) is commonly used.

The closure cap 18 typically comprises a polymer shell 26 with a top surface 28 with a skirt 30 depending therefrom. Examples of suitable polymers include polypropylene or polyethylene polymer. The skirt includes internal threads 32 for mating with the external threads 16, provided on the neck finish 14. The underside of the top surface 28 of the closure cap 18 may optionally include a liner 34 made of a resilient material for sealing the interfacing surfaces of the closure cap 18 and the container lip. Alternatively, the closure cap 18 may be linerless.

In order to permit the equalization of pressure between the container interior and the ambient atmosphere during cooling of the container after hot filling, the closure cap is provided with a through-hole 36 in its top surface and associated liner 34. Alternatively, the hole 36 can be located in the skirt portion 36 or the cap 18. The hole 36 has a diameter on the order of 50 microns to 100 microns. The through-hole 36 is covered on its interior side with a membrane 38 made of a hydrophobic, air permeable material, such as expanded polytetraflouro-ethylene (ePTFE) or polypropylene, that serves as a vent. The vent membrane 38 has a porosity of between about 20 percent and 40 percent, and preferably 30 percent, with an average pore size of from about 0.3 to 5.0 microns. Preferably, the pore size is from about 0.4 to 2.0 microns, and, more preferably from about 0.5 to 1.5 microns. In practice, an average pore size of about 1.0 micron has been found to provide satisfactory results.

In keeping with the invention, the vent membrane 38 is provided with a seal 40 after the contents of the bottle has been cooled to ambient temperature. The seal 40 prevents any further ingress or egress of gaseous fluids with respect to the interior of the container 10. The seal 40 can be any food grade material that forms both an oxygen and moisture barrier, and may be in the form of a coating, such as a UV activatable material, a composition which solidified upon exposure to actinic radiation, paint, or semi-transparent adhesive that the seal 40 fills the hole 36 resulting in the seal 40 being flush with the top surface 28 of the closure cap 18. Alternatively, the seal 40 may comprise an air-tight plastic membrane with a pressure-sensitive adhesive on one side that is applied over the hole 36 on the outside of the top surface 28 on the closure cap 18.

In an alternative embodiment, the container itself can be provided with the vent, rather than the closure cap. As seen in the drawings, the container 10 may include a through-hole 136 in its shoulder portion above the liquid level or fill line 42 of the container 10. The through-hole 136 is provided with a vent membrane 138 disposed on the interior of the container 10, which is provided with a seal 140 after cooling, all as described above.

Based on the foregoing, the method of the present invention should be self-evident. Either the cap or the shoulder portion of the container above the fill line is provided with a through-hole that is covered with a hydrophobic, air permeable membrane. When the container is filled with a hot liquid and the cap is applied to the filled container. The container is then cooled to ambient temperature. During cooling, air can pass through the membrane to permit equalization between the pressure on the interior of the container and ambient pressure. After cooling, an air-tight seal is applied over the membrane-covered hole, thus preventing any further migration of air across the membrane and resulting in a container having a substantially air-tight, as well as liquid-tight, seal.

Thus, a hot fill method and associated container or closure has been provided that meets the objects of the present invention. As a result, the container no longer requires the deformable vacuum panels in its body portion that are commonly found in hot-fill polymer containers. With the vacuum panels eliminated, the design of the container is greatly simplified and, for example, a functionally grippable profile is more easily provided.

While the invention has been described in terms of certain preferred embodiments, there is no intent to limit the invention to the same. Indeed, while the invention is shown in connection with a polymer bottle, the vent membrane and seal may also be used on other types of aseptic, hot-fill containers, such as pouches and boxes. Consequently, the invention is defined by the scope of the following claims.

What is claimed:

1. A method of hot-filling and capping a polymer container, the container defining head space area above a level of liquid in the filled container, comprising:
providing one of the closure and the head space area of the container with a hole covered with hydrophobic air permeable membrane;
filling the container with hot liquid;
applying the closure to the filled container;
allowing the filled container to cool; and
applying an air tight seal over the membrane-covered hole.

2. The method of claim 1 wherein hydrophobic air permeable membrane comprises expanded polytetraflouro-ethylene.

3. The method of claim 1 wherein hydrophobic air permeable membrane comprises polypropylene.

4. The method of claim 1 wherein the membrane has pores sized from about 0.3 to 5 microns.

5. The method of claim 1 wherein the membrane has pores sized from about 0.4 to 2 microns.

6. The method of claim 1 wherein the membrane has pores sized from about 0.5 to 1.5 microns.

7. The method of claim 1 wherein the membrane has pores having an average of about 1.0 micron.

8. The method of claim 1 wherein the hole is sized between about 50 and 100 microns.

9. The method of claim 1 wherein the seal comprises a dryable coating.

10. The method of claim 1 wherein the dryable coating comprises a UV activated sealant.

11. The method of claim 1 wherein the dryable coating comprises a paint.

12. The method of claim 1 wherein the seal comprises a semi-transparent adhesive.

13. The method of claim 1 wherein the seal comprises an air tight membrane with a pressure-sensitive adhesive on one surface thereof.

14. The method of claim wherein the seal comprises a composition which solidifies upon exposure to actinic radiation.

15. A closure cap adapted to be applied to a hot-fill container comprising:
a top surface having an outer edge with a skirt portion depending therefrom, the top surface defining a hole therethrough;
a hydrophobic, air permeable membrane secured to the cap so as to fill the hole; and
an air-tight seal over the portion of the membrane filling the hole.

16. The closure cap of claim 15 in which the hydrophobic air permeable membrane is secured to the inside surface of the top and further comprises a liner applied to the inside surface of the cap, the liner having a hole in registration with the hole in the top surface and overlying the hydrophobic air permeable membrane.

17. The closure cap of claim 15 wherein hydrophobic air permeable membrane comprises expanded polytetraflouro-ethylene.

18. The closure cap of claim 15 wherein hydrophobic air permeable membrane comprises polypropylene.

19. The closure cap of claim 15 wherein the membrane has pores sized from about 0.3 to 5 microns.

20. The closure cap of claim 15 wherein the membrane has pores sized from about 0.4 to 2 microns.

21. The closure cap of claim 15 wherein the membrane has pores sized from about 0.5 to 1.5 microns.

22. The closure cap of claim 15 wherein the membrane has pores having an average of about 1.0 micron.

23. The closure cap of claim 15 wherein the hole is sized between about 50 and 100 microns.

24. The closure of claim 15 wherein the seal comprises a dryable coating.

25. The closure of claim 15 wherein the dryable coating comprises a UV activated sealant.

26. The closure cap of claim 15 wherein the dryable coating comprises a paint.

27. The closure cap of claim 15 wherein the seal comprises a semi-transparent adhesive.

28. The closure cap of claim 15 wherein the seal comprises an air tight membrane with a pressure-sensitive adhesive on one surface thereof.

29. The closure cap of claim 15 wherein the seal comprises a composition which solidifies upon exposure to actinic radiation.

30. A hot-fill container defining a head space area above the level to which the container is to be filled with liquid, the head space area defining a hole therethrough;
a hydrophobic, air permeable membrane secured to the container so as to cover hole; and
an air tight seal over the portion of the membrane covering the hole.

31. The container of claim 30 wherein hydrophobic air permeable membrane comprises expanded polytetraflouro-ethylene.

32. The container of claim 30 wherein hydrophobic air permeable membrane comprises polypropylene.

33. The container of claim 30 wherein the membrane has pores sized from about 0.3 to 5 microns.

34. The container of claim 30 wherein the membrane has pores sized from about 0.4 to 2 microns.

35. The container of claim 30 wherein the membrane has pores sized from about 0.5 to 1.5 microns.

36. The container of claim 30 wherein the membrane has pores having an average of about 1.0 micron.

37. The container of claim 30 wherein the hole is sized between about 50 and 100 microns.

38. The container of claim 30 wherein the seal comprises a dryable coating.

39. The container of claim 30 wherein the dryable coating comprises a UV activated sealant.

40. The container of claim 30 wherein the dryable coating comprises a paint.

41. The container of claim 30 wherein the seal comprises a semi-transparent adhesive.

42. The container of claim 30 wherein the seal comprises an air tight membrane with a pressure-sensitive adhesive on one surface thereof.

43. The container of claim 30 wherein the seal comprises a composition which solidifies upon exposure to actinic radiation.

44. A closure cap adapted to be applied to a hot-fill container comprising:
a top surface having an outer edge with a skirt portion depending therefrom, the skirt portion defining a hole therethrough;
a hydrophobic, air permeable membrane secured to the cap so as to fill the hole; and
an air-tight seal over the portion of the membrane filling the hole.

45. The closure cap of claim 44 wherein hydrophobic air permeable membrane comprises expanded polytetraflouro-ethylene.

46. The closure cap of claim 44 wherein hydrophobic air permeable membrane comprises polypropylene.

47. The closure cap of claim 44 wherein the membrane has pores sized from about 0.3 to 5 microns.

48. The closure cap of claim 44 wherein the membrane has pores sized from about 0.4 to 2 microns.

49. The closure cap of claim 44 wherein the membrane has pores sized from about 0.5 to 1.5 microns.

50. The closure cap of claim 44 wherein the membrane has pores having an average of about 1.0 micron.

51. The closure cap of claim 44 wherein the hole is sized between about 50 and 100 microns.

52. The closure of claim 44 wherein the seal comprises a dryable coating.

53. The closure of claim 44 wherein the dryable coating comprises a UV activated sealant.

54. The closure cap of claim 44 wherein the dryable coating comprises a paint.

55. The closure cap of claim 44 wherein the seal comprises a semi-transparent adhesive.

56. The closure cap of claim 44 wherein the seal comprises an air tight membrane with a pressure-sensitive adhesive on one surface thereof.

57. The closure cap of claim 44 wherein the seal comprises a composition which solidifies upon exposure to actinic radiation.
